(19) United States
(12) Patent Application Publication
(10) Pub. No.: US 2021/0250225 A1
(43) Pub. Date: Aug. 12, 2021

(54) DYNAMIC LINK RECOVERY

(71) Applicant: QUALCOMM Incorporated, San Diego, CA (US)

(72) Inventors: Vishal Agarwal, Bangalore (IN); Giriraj Goyal, Bangalore (IN)

(21) Appl. No.: 16/783,343

(22) Filed: Feb. 6, 2020

(51) Int. Cl. H04L 12/24; H04L 1/00; H04L 5/00; H04L 12/801

(52) U.S. Cl. CPC H04L 41/0654; H04L 1/0061; H04W 84/12; H04L 47/34; H04L 5/0044; H04L 5/0055

(57) ABSTRACT

Methods, systems, and devices for dynamic link recovery are described. Generally, a first device may transmit a first packet to a second device using a first set of transmission parameters, and may monitor for a feedback message from the second device. The first device may not receive a feedback message, and may therefore generate a second packet with the same sequence number as the first packet, and may introduce an error to the second packet that will trigger a feedback message from the second device, and may transmit the second packet to the second device using second transmission parameters (e.g., that are more robust than the first transmission parameters). The first device may monitor for and receive a feedback message from the second device.

### BACKGROUND

The following relates generally to wireless communications, and more specifically to dynamic link recovery.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. In some examples, a wireless device may communicate with one or more other devices in an environment that is prone to rapid changes in interference, or may pass through a noisy geographic area resulting in increased interference.

### SUMMARY

The described techniques relate to improved methods, systems, devices, and apparatuses that support dynamic link recovery. Generally, a first device may transmit a first packet to a second device using a first set of transmission parameters, and may monitor for a feedback message from the second device. The first device may not receive a feedback message, and may therefore generate a second packet with the same sequence number as the first packet, and may introduce an error to the second packet that will trigger a feedback message from the second device, and may transmit the second packet to the second device using second transmission parameters (e.g., that are more robust than the first transmission parameters). The first device may monitor for and receive a feedback message from the second device. If the feedback message is an acknowledgement (ACK) message, then the second device previously received the first packet. In such cases, the first device may subsequently transmit a third packet having a new sequence number. If the feedback message is a negative acknowledgement (NACK) message, then the second device did not previously receive the first packet. In such cases, the second device may have attempted to decode the packet, and upon identifying the error, may have transmitted the NACK. In such examples, the first device may retransmit the payload of the first packet in one or more new packets.

A method of wireless communications at a first device is described. The method may include transmitting, to a second device, a first packet using a first sequence number, a first payload, and a first set of one or more transmission parameters, monitoring, based on transmitting the first packet, for a first feedback message from the second device, generating, based on the monitoring, a second packet including an error, the second packet using the first sequence number, a second payload, and a second set of one or more parameters different than the first set of one or more parameters, transmitting the generated second packet to the second device, monitoring, based on transmitting the second packet, for a second feedback message from the second device, and receiving the second feedback message from the second device based on monitoring for the second feedback message.

An apparatus for wireless communications at a first device is described. The apparatus may include a processor, memory coupled with the processor, and instructions stored in the memory. The instructions may be executable by the processor to cause the apparatus to transmit, to a second device, a first packet using a first sequence number, a first payload, and a first set of one or more transmission parameters, monitor, based on transmitting the first packet, for a first feedback message from the second device, generate, based on the monitoring, a second packet including an error, the second packet using the first sequence number, a second payload, and a second set of one or more parameters different than the first set of one or more parameters, transmit the generated second packet to the second device, monitor, based on transmitting the second packet, for a second feedback message from the second device, and receive the second feedback message from the second device based on monitoring for the second feedback message.

Another apparatus for wireless communications at a first device is described. The apparatus may include means for transmitting, to a second device, a first packet using a first sequence number, a first payload, and a first set of one or more transmission parameters, monitoring, based on transmitting the first packet, for a first feedback message from the second device, generating, based on the monitoring, a second packet including an error, the second packet using the first sequence number, a second payload, and a second set of one or more parameters different than the first set of one or more parameters, transmitting the generated second packet to the second device, monitoring, based on transmitting the second packet, for a second feedback message from the second device, and receiving the second feedback message from the second device based on monitoring for the second feedback message.

A non-transitory computer-readable medium storing code for wireless communications at a first device is described. The code may include instructions executable by a processor to transmit, to a second device, a first packet using a first sequence number, a first payload, and a first set of one or more transmission parameters, monitor, based on transmitting the first packet, for a first feedback message from the second device, generate, based on the monitoring, a second packet including an error, the second packet using the first sequence number, a second payload, and a second set of one or more parameters different than the first set of one or more parameters, transmit the generated second packet to the second device, monitor, based on transmitting the second packet, for a second feedback message from the second device, and receive the second feedback message from the second device based on monitoring for the second feedback message.

Some examples of the method, apparatuses, and non-transitory computer-readable medium described herein may further include operations, features, means, or instructions for transmitting, to the second device, a third packet having a second sequence number, a third payload, and the second set of one or more parameters, where the second feedback message includes a positive acknowledgement message.

Some examples of the method, apparatuses, and non-transitory computer-readable medium described herein may further include operations, features, means, or instructions for transmitting, to the second device, one or more packets using the first sequence number, the first payload, and the second set of one or more transmission parameters.

Some examples of the method, apparatuses, and non-transitory computer-readable medium described herein may further include operations, features, means, or instructions for identifying a feedback message threshold time, and determining, based on monitoring for the first feedback message, that the feedback message threshold time may have expired and the first device may have not received the first feedback message, where generating the second packet may be based on the determining.

In some examples of the method, apparatuses, and non-transitory computer-readable medium described herein, the first set of one or more transmission parameters includes a first packet size, a first modulation order, a first coding rate, or a combination thereof, and where the second set of one more transmission parameters includes a second packet size, a second modulation order, a second coding rate, or a combination thereof.

In some examples of the method, apparatuses, and non-transitory computer-readable medium described herein, the error includes a cyclic redundancy check (CRC) error, or a message integrity check (MIC) error.

In some examples of the method, apparatuses, and non-transitory computer-readable medium described herein, the first payload and the second payload may be the same.

In some examples of the method, apparatuses, and non-transitory computer-readable medium described herein, the first payload and the second payload may be different.

### BRIEF DESCRIPTION OF THE DRAWINGS

FIG. 1 illustrates an example of a system for wireless communications that supports dynamic link recovery in accordance with aspects of the present disclosure.

FIG. 2 illustrates an example of a process flow that supports dynamic link recovery in accordance with aspects of the present disclosure.

FIG. 3 illustrates an example of a process flow that supports dynamic link recovery in accordance with aspects of the present disclosure.

FIGS. 4 and 5 show block diagrams of devices that support dynamic link recovery in accordance with aspects of the present disclosure.

FIG. 6 shows a block diagram of a communications manager that supports dynamic link recovery in accordance with aspects of the present disclosure.

FIG. 7 shows a diagram of a system including a device that supports dynamic link recovery in accordance with aspects of the present disclosure.

FIGS. 8 through 10 show flowcharts illustrating methods that support dynamic link recovery in accordance with aspects of the present disclosure.

### DETAILED DESCRIPTION

A first device (e.g., a wireless device, a phone, a music player, a source device in a Bluetooth communications system, or the like) may communicate with a second device (e.g., a wireless device, wireless earbuds, speakers, a slave device in a Bluetooth communications system, or the like). The first device may transmit one or more packets to the second device. In some examples, communications between the first device and the second UE may be particularly prone to errors. For example, the first device may transmit packets to the second device at a high modulation, a high coding rate, a large packet size, or a combination thereof. If the environment changes rapidly (e.g., a WiFi system is activated at or close to the same location as the first device, or a user carries the first deice through a particularly noisy geographic area), then it may be more likely that the second device will fail to receive packets transmitted by the first device, or that the first device will fail to receive feedback messages (e.g., acknowledgement (ACK) messages or negative acknowledgement (NACK) messages) from the second device. If the second device fails to receive a packet from the first device, the first device may send one or more retransmissions of the first packet. Or, if the second device transmits an ACK message to the first device upon receiving a packet, but the first device does not receive the ACK message, then the first device may send one or more retransmission of the first packet. In either case, the first device may be unaware of whether the second device has received the packet, and may transmit and retransmit the packet indefinitely, resulting in poor throughput on a wireless link. Poor throughput may result in glitching or pausing in data streaming (e.g., audio or media streaming from the first device to the second device), and decreased user experience.

To avoid the indefinite loop of retransmissions, the first device may transmit a more robust packet with an error to the second device. For example, the first device may transmit a second packet using more robust transmission parameters (e.g., a lower modulation, lower coding rate, smaller size, or a combination thereof. The first device may introduce an error into the more robust packet (e.g., a cyclic redundancy check (CRC) error, or a message integrity check (MIC) error), and may transmit the second packet with the same sequence number (SEQN) as the first packet. Thus, if the second device has already received the first packet, it will recognize the same SEQN and send an ACK message. The second device may also transmit the ACK message using the more robust transmission parameters (e.g., lower modulation, lower coding rate, smaller packet size, etc.), thus increasing the likelihood that the first device will receive the ACK message. If the second device has not previously received the first packet, then upon attempting to decode the second packet, the second device will identify the error and transmit a NACK message to the first device using the more robust transmission parameters. Upon receiving the NACK message, the first device may transmit one or more packets to the second device using the more robust transmission parameters. The one or more packets may include the payload of the first packet.

Aspects of the disclosure are initially described in the context of a multimedia system, and process flows. Aspects of the disclosure are further illustrated by and described with reference to apparatus diagrams, system diagrams, and flowcharts that relate to dynamic link recovery.

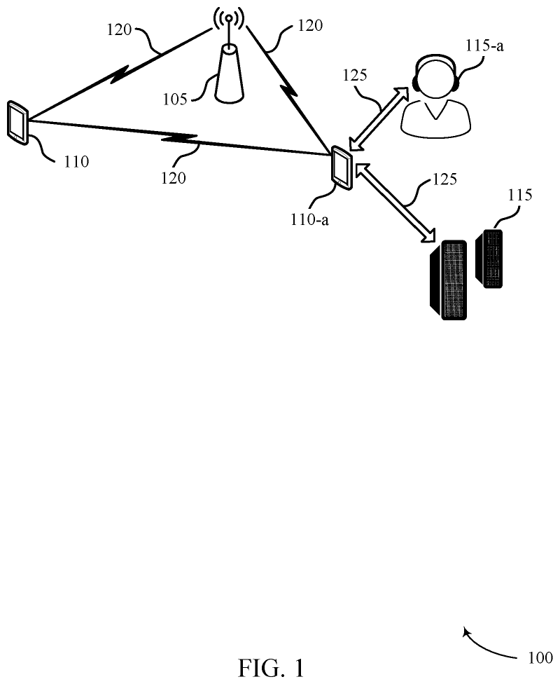

FIG. 1 illustrates an example of a wireless communications system 100 that supports dynamic link recovery in accordance with aspects of the present disclosure. In some examples, the wireless communications system 100 may include or refer to a wireless personal area network (PAN), a wireless local area network (WLAN), a Wi-Fi network) configured in accordance with various aspects of the present disclosure. The wireless communications system 100 may include an access point (AP) 105, devices 110 (e.g., which may be referred to as source devices, master devices, etc.), and paired devices 115 (e.g., which may be referred to as sink devices, slave devices, etc.) implementing WLAN communications (e.g., Wi-Fi communications) and/or Bluetooth communications. For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 110), which may include wireless audio devices (e.g., headsets, earbuds, speakers, ear pieces, headphones), display devices (e.g., TVs, computer monitors), microphones, meters, valves, etc.

Bluetooth communications may refer to a short-range communication protocol and may be used to connect and exchange information between devices 110 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a master-slave relationship employing a time-division duplex protocol having, for example, defined time slots of 625 mu seconds, in which transmission alternates between the master device (e.g., a device 110) and one or more slave devices (e.g., paired devices 115). In some examples, a device 110 may generally refer to a master device, and a paired device 115 may refer to a slave device in the wireless communications system 100. As such, in some examples, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the wireless communications system 100. Generally, device 110 may refer to a wireless communication device capable of wirelessly exchanging data signals with another device (e.g., a paired device 115), and paired device 115 may refer to a device operating in a slave role, or to a short-range wireless communication device capable of exchanging data signals with the device 110 (e.g., using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (e.g., roles for a device 110 and a paired device 115) that together form a single use case called a profile (e.g., for communications between the device 110 and the paired device 115). One example profile defined in the Bluetooth specification is the Handsfree Profile (HFP) for voice telephony, in which one device (e.g., a device 110) implements an Audio Gateway (AG) role and the other device (e.g., a paired device 115) implements a Handsfree (HF) device role. Another example is the Advanced Audio Distribution Profile (A2DP) for high-quality audio streaming, in which one device (e.g., device 110) implements an audio source device (SRC) role and another device (e.g., paired device 115) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement mechanisms, repeat mechanisms, sequence numbering, scheduling behavior, etc.). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-less (ACL) links, (or ACL connections), synchronous connection orientated (SCO) links (or SCO connections), extended synchronous connection-oriented (eSCO) links (or eSCO connections), other logical transport channel links, etc.

In some examples, the controller stack may implement link management protocol (LMP) functions, low energy link layer (LELL) functions, etc. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some examples, the controller stack and the host stack may communicate via a host controller interface (HCI). In other cases, (e.g., for integrated devices such as Bluetooth headsets), the host stack and controller stack may be run on the same microprocessor to reduce mass production costs. For such host-less systems, the HCI may be optional, and may be implemented as an internal software interface.

A connection link 125 may be established between two Bluetooth-enabled devices (e.g., between a device 110 and a paired device 115) and may provide for communications or services (e.g., according to some Bluetooth profile). For example, a Bluetooth connection may be an eSCO connection for voice call (e.g., which may allow for retransmission), an ACL connection for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired device 115) are acknowledged, and may be retransmitted if not acknowledged during a retransmission window. In addition, audio may be streamed between a device 110 and a paired device 115 using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. In some cases the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within system 100, and devices may communicate with each other via communication links 120 (e.g., Wi-Fi Direct connections, Wi-Fi Tunneled Direct Link Setup (TDLS) links, peer-to-peer communication links, other peer or group connections). AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device110) and uplink (e.g., the communication link from the device 110 to the AP 105).

In some examples, content, media, audio, etc. exchanged between a device 110 and a paired device 115 may originate from a WLAN. For example, in some examples, device 110 may receive audio from an AP 105 (e.g., via WLAN communications), and the device 110 may then relay or pass the audio to the paired device 115 (e.g., via Bluetooth communications). In some examples, certain types of Bluetooth communications (e.g., such as high quality or high definition (HD) Bluetooth) may require enhanced quality of service. For example, in some examples, delay-sensitive Bluetooth traffic may have higher priority than WLAN traffic.

Aspects of the techniques described herein may be performed by any combination of devices (e.g., a first and second device) in communication with each other in one or more wireless communications systems (e.g., a WiFi system, a Bluetooth system, or the like). Illustrative examples described herein may be described with respect to a first device (e.g., a transmitting device, such as a device 110 as described with reference to FIG. 1), and a second device (e.g., a receiving device, such as a paired device 115 as described with reference to FIG. 1). However, the described techniques may also be performed by other combinations of devices in a variety of scenarios (e.g., a first device 110 and a second device 110, an AP 105 and a device 110, a master true wireless stereo (TWS) earbud and a slave TWS earbud, or the like).

In some examples, a device 110 may be in communication with a paired device 115. Device 110 may transmit packets that may be more error prone than others. That is, longer or larger packets (e.g., high speed packets, low energy high sensitivity (LEHS) packets, etc.), packets transmitted at a high modulation or high coding rate, or the like, may be more prone to error in certain circumstances. For instance, a user may carry device 110 or paired device 115 into an area where WiFi communications are more active, or WiFi may be activated in the location of one or both of device 110 and paired device 115. In some examples,=a user may carry device 110 or paired device 115 away, resulting in a sudden increase in physical distance between device 110 and paired device 115. In such examples, when sudden changes occur during data transfer, packets may be more prone to error (e.g., less likely to be successfully received or decoded).

If device 110 is unaware of whether paired device 115 has received a packet, then device 110 cannot replace the packet with a new packet. This may result in multiple retransmissions. For example, if the paired device 115 fails to receive a packet from the device 110, then paired device 115 may not transmit an ACK or a NACK, and the device 110 may send one or more retransmissions of the first packet. Or, if the paired device 115 transmits an ACK message to the device 110 upon receiving a packet, but the device 110 does not receive the ACK message, then the device 110 may send one or more retransmission of the first packet. In either case, the device 110 may be unaware of whether the paired device 115 has received the packet, and may transmit and retransmit the packet indefinitely, resulting in poor throughput on a wireless link. Poor throughput may result in glitching or pausing in data streaming (e.g., audio or media streaming from the device 110 to the paired device 115), and decreased user experience.

In some examples, device 110 may be able to transmit the same payload of the previous packet in a smaller (more robust packet). However, the length of the previously transmitted packet may not fit in a lower physical layer packet (e.g., a smaller packet).

In some examples, the previously transmitted packet may include a header and payload transmitted using the same modulation scheme. In such examples, if the previously transmitted packet was transmitted in error prone conditions (e.g., a high level of unexpected interference resulting in corrupted payload), then paired device 115 may be unable to receive even the header of the previously transmitted packet. In such circumstances, paired device 115 may not be able to decode even enough of the previously transmitted packet to transmit a NACK to device 110.

To avoid the indefinite loop of retransmissions, the device 110 may transmit a more robust packet (e.g., using different transmission parameters) with an error to the paired device 115. Paired device 115 may be more likely to receive the more robust packet, but will discard the packet as a result of the error. If paired device 115 has not previously received the packet, then it will transmit a NACK message to device 110. If paired device 115 has received the packet previously, then it will recognize the same SEQN of the packet, discard it, and transmit an ACK message (regardless of the packet error). If device 110 receives a NACK message, it may retransmit the data using different transmission parameters (e.g., transmit the payload of the packet using more robust transmission parameters (e.g., one or more smaller packets, lower modulation scheme, lower coding rate, or the like). If device 110 receives an ACK message, then it may assume that the packet is successfully received and may transmit a new packet using the more robust transmission parameters (e.g., packets, lower modulation scheme, lower coding rate, or the like).

For example, the device 110 may transmit a second packet using more robust transmission parameters (e.g., a lower modulation, lower coding rate, smaller size, or a combination thereof. The device 110 may introduce an error into the more robust packet (e.g., a cyclic redundancy check (CRC) error, or a message integrity check (MIC) error), and may transmit the second packet with the same sequence number (SEQN) as the first packet. Thus, if the paired device 115 has already received the first packet, it will recognize the same SEQN and send an ACK message. The paired device 115 may also transmit the ACK message using the more robust transmission parameters (e.g., lower modulation, lower coding rate, smaller packet size, etc.), thus increasing the likelihood that the device 110 will receive the ACK message. If the paired device 115 has not previously received the first packet, then upon attempting to decode the second packet, the paired device 115 will identify the error and transmit a NACK message to the device 110 using the more robust transmission parameters. Upon receiving the NACK message, the device 110 may transmit one or more packets to the paired device 115 using the more robust transmission parameters. The one or more packets may include the payload of the first packet.

Techniques described herein may further be utilized in synchronous connection oriented (SCO) window. For example, transmission of longer packets (e.g., five-slot packets) during an SCO window may result in indefinite retransmissions, as described above. A device 110 may drop SCO packets in order to complete a five-slot packet, which may be done upon detecting an access code of the packet. However, an access code of a five-slot packet may collide with an SCO anchor. The techniques described herein may be more successful in dynamically salvaging a link that is stuck in retransmissions than dropping SCO packets to complete five-slot packets.

The techniques described herein may provide improvements in wireless communication. Furthermore, the techniques described herein may provide benefits and enhancements to the operation of the devices 110 and paired device 115. For example, by transmitting robust packets with intentional errors, indefinite loops of retransmissions may be broken or avoided, resulting in improved throughput, decreased glitching and pausing of data transmissions, and improved user experience.

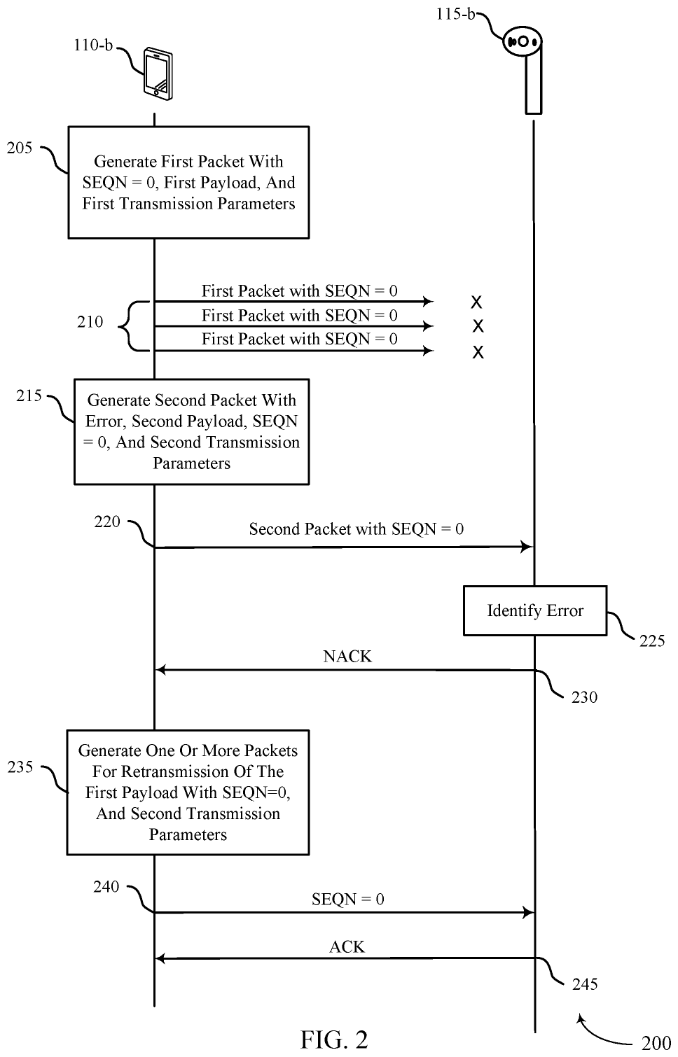

FIG. 2 illustrates an example of a process flow 200 that supports dynamic link recovery in accordance with aspects of the present disclosure. In some examples, process flow 200 may implement aspects of wireless communication system 100.

At 205, device 110-b may generate a first packet with a first SEQN (e.g., SEQN=0). The first packet may have a first payload (e.g., video data, audio data, measurement data, etc.). The first packet may also be transmitted using first transmission parameters. In some examples, the first transmission parameters may not be very robust (e.g., may be error prone in noisy or rapidly changing environments, as described with reference to FIG. 1). The first transmission parameters may include larger (e.g., 5-slot or 6-slot) packet size, high modulation scheme, high coding rate, or the like. At 210, device 110-b may transmit the first packet with SEQN=0 to paired device 115-b multiple times. However, as a result of the environment and the first transmission parameters, paired device 115-b may fail to receive the first packet. Device 110-b may retransmit the first packet multiple times when it does not receive feedback messages, such as an ACK message or a NACK message (e.g., as part of an automatic repeat request (ARQ) protocol, a hybrid automatic repeat request protocol (HARQ), or the like) responsive to each transmission of the first packet at 210.

In some examples, device 110-b may determine, based on monitoring for feedback messages from paired device 115-b, to generate a second packet with an error. For example, device 110-b may identify a threshold amount of time during which to wait for feedback information. The threshold amount of time may include a number of transmissions of the first packet, a number of transmission time intervals during which to retransmit and monitor for feedback information, an amount of time, or the like. In some examples, upon transmitting the first packet (e.g., for the first time, or after a number of retransmissions), device 110-b may initiate a timer. Upon expiration of the timer, device 110-b may generate the second packet.

At 215, device 110-b may generate a second packet with an error, a second payload, and the same SEQN (e.g., SEQN=0) as the first packet. In some examples, the second packet may be based on the first packet, with one or more changes to the contents of the packet resulting in a CRC error. In some examples, the second packet may be a dummy packet generated to produced a CRC error. In some examples, the error may be a MIC error generated by device 110-b. The error may result in the second packet being discarded by paired device 115-b, but may also result in reliable feedback from paired device 115-b.

At 220, device 110-b may transmit the second packet using second transmission parameters. The second transmission parameters may be more robust than the first transmission parameters. The second transmission parameters may include, a smaller packet size, a lower modulation scheme, a lower coding rate, or the like. Paired device 115-b may be more likely to successfully receive the second packet because of the second transmission parameters. Paired device 115-b may receive the second packet at 220. Having not received the first packet with SEQN=0, paired device 115-b may identify the second packet as a new packet.

At 225, having successfully received the second packet, paired device 115-b may identify the error (e.g., the CRC error, MIC error, or the like), and may discard the second payload.

At 230, based on the error identified at 225, paired device 115-b may transmit a NACK message to device 110-b.

At 235, having received the NACK message at 230, device 110-b may generate one or more packets for retransmission of the first payload using the second transmission parameters. For example, if the second parameters include a smaller packet size, then at 235 device 110-b may generate a set of smaller packets for transmission to paired device 115-b. In some examples, device 110-b may generate the one or more packets for transmission using the lower modulation scheme, the lower coding rate, or both.

At 240, device 110-b may transmit the one or more packets to paired device 115-b using the same SEQN (SEQN=0) as the first packet, using the second parameters to increase the likelihood that paired device 115-b will receive the one or more packets. Paired device 115-b may receive the one or more transmissions in response to the NACK transmitted at 230, and may transmit an ACK message at 245. Subsequently, device 110-b may generate and transmit new packets (e.g., a next packet having a SEQN=1).

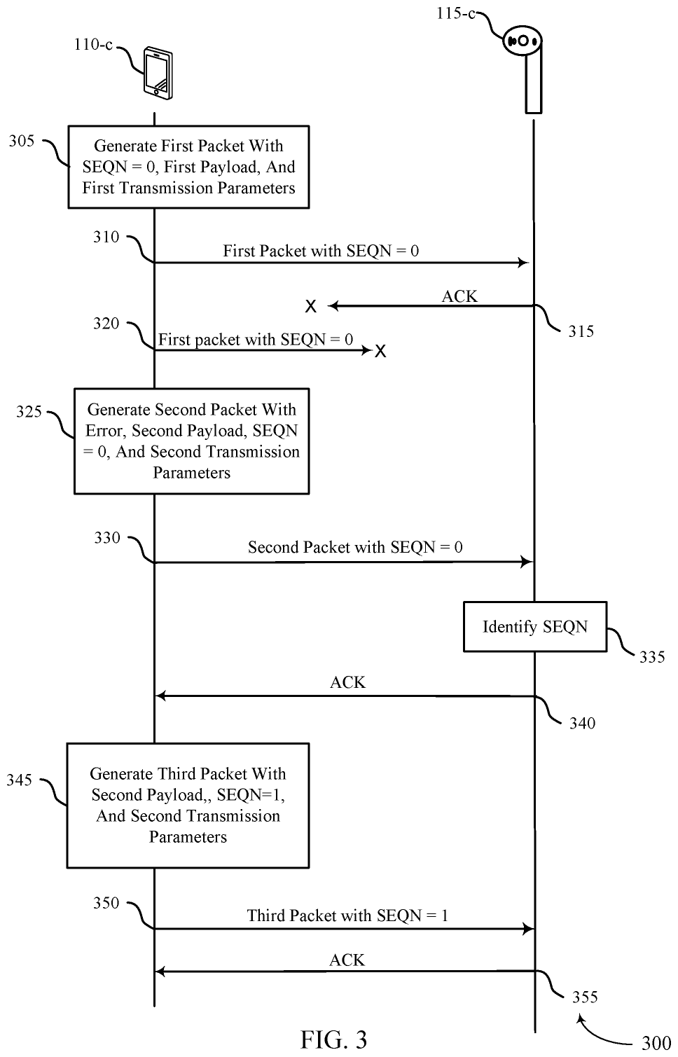

FIG. 3 illustrates an example of a process flow 300 that supports dynamic link recovery in accordance with aspects of the present disclosure. In some examples, process flow 300 may implement aspects of wireless communication system 100, and process flow 200.

At 305, device 110-c may generate a first packet with a first SEQN (e.g., SEQN=0). The first packet may have a first payload (e.g., video data, audio data, measurement data, etc.). The first packet may also be transmitted using first transmission parameters. In some examples, the first transmission parameters may not be very robust (e.g., may be error prone in noisy or rapidly changing environments, as described with reference to FIG. 1). The first transmission parameters may include larger (e.g., 5-slot or 6-slot) packet size, high modulation scheme, high coding rate, or the like.

At 310, device 110-c may transmit the first packet with SEQN=0 to paired device 115-c using the first transmission parameters. Paired device 115-c may successfully receive the first packet.

At 315, paired device 115-c may transmit an ACK message to device 110-c. In some examples, paired device 115-c may transmit the ACK message using the first transmission parameters. However, as a result of the environment and the first transmission parameters, first device 110-c may fail to receive the ACK message at 315. Device 110-c may retransmit the first packet using the first transmission parameters at 320 (e.g., because it does not receive a feedback message from paired device 115-c at 315). However, as a result of the environment and the first transmission parameters, paired device 115-c may not receive the first packet.

In some examples, device 110-c may determine, based on monitoring for feedback messages from paired device 115-c, to generate a second packet with an error. For example, device 110-c may identify a threshold amount of time during which to wait for feedback information. The threshold amount of time may include a number of transmissions of the first packet, a number of transmission time intervals during which to retransmit and monitor for feedback information, an amount of time, or the like. In some examples, upon transmitting the first packet (e.g., for the first time, or after a number of retransmissions), device 110-c may initiate a timer. Upon expiration of the timer, device 110-c may generate the second packet.

At 325, device 110-c may generate a second packet with an error, a second payload, and the same SEQN (e.g., SEQN=0) as the first packet. In some examples, the second packet may be based on the first packet, with one or more changes to the contents of the packet resulting in a CRC error. In some examples, the second packet may be a dummy packet generated to produce a CRC error. In some examples, the error may be a MIC error generated by device 110-c. The error may result in the second packet being discarded by paired device 115-c, but may also result in reliable feedback from paired device 115-c.

At 330, device 110-c may transmit the second packet using second transmission parameters. The second transmission parameters may be more robust than the first transmission parameters. The second transmission parameters may include, a smaller packet size, a lower modulation scheme, a lower coding rate, or the like. Paired device 115-c may be more likely to successfully receive the second packet because of the second transmission parameters. Paired device 115-c may receive the second packet at 330.

Having previously received the first packet with SEQN=0 at 310, paired device 115-c may identify the SEQN=0 of the second packet. Paired device 115-c may determine that the second packet is not a new packet. Paired device 115-c may discard the second packet, and (despite the introduced error), may transmit an ACK message at 340.

At 340, having determined that the first packet was previously received (including the first payload), paired device 115-c may transmit an ACK message to device 110-c. In some examples, paired device 115-c may transmit the ACK message using the second transmission parameters. That is, upon receiving the second packet transmitted using the second transmission parameters, paired device 115-c may generate the ACK message and transmit it using the second transmission parameters (instead of the first transmission parameters used to transmit the ACK message at 315.

At 345, having received the ACK message at 340, device 110-c may generate one or more packets for retransmission of the first payload using the second transmission parameters. For example, if the second parameters include a smaller packet size, then at 345 device 110-c may generate a set of smaller packets for transmission to paired device 115-c. In some examples, device 110-c may generate the one or more packets for transmission using the lower modulation scheme, the lower coding rate, or both.

At 350, device 110-c may transmit the one or more packets to paired device 115-c using a second SEQN (SEQN=1), using the second parameters to increase the likelihood that paired device 115-c will receive the one or more packets. Paired device 115-c may receive the one or more transmissions at 355, and may transmit an ACK message at 355.

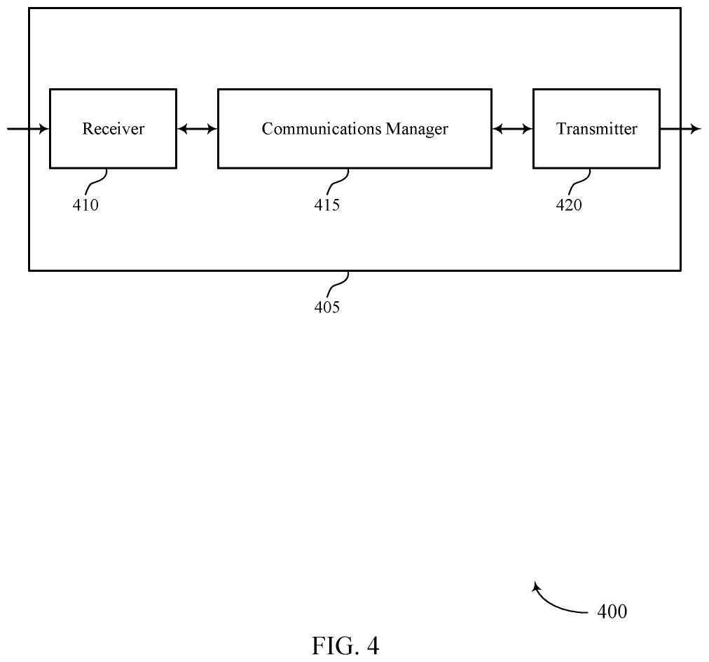

FIG. 4 shows a block diagram 400 of a device 405 that supports dynamic link recovery in accordance with aspects of the present disclosure. The device 405 may be an example of aspects of a device as described herein. The device 405 may include a receiver 410, a communications manager 415, and a transmitter 420. The device 405 may also include a processor. Each of these components may be in communication with one another (e.g., via one or more buses).

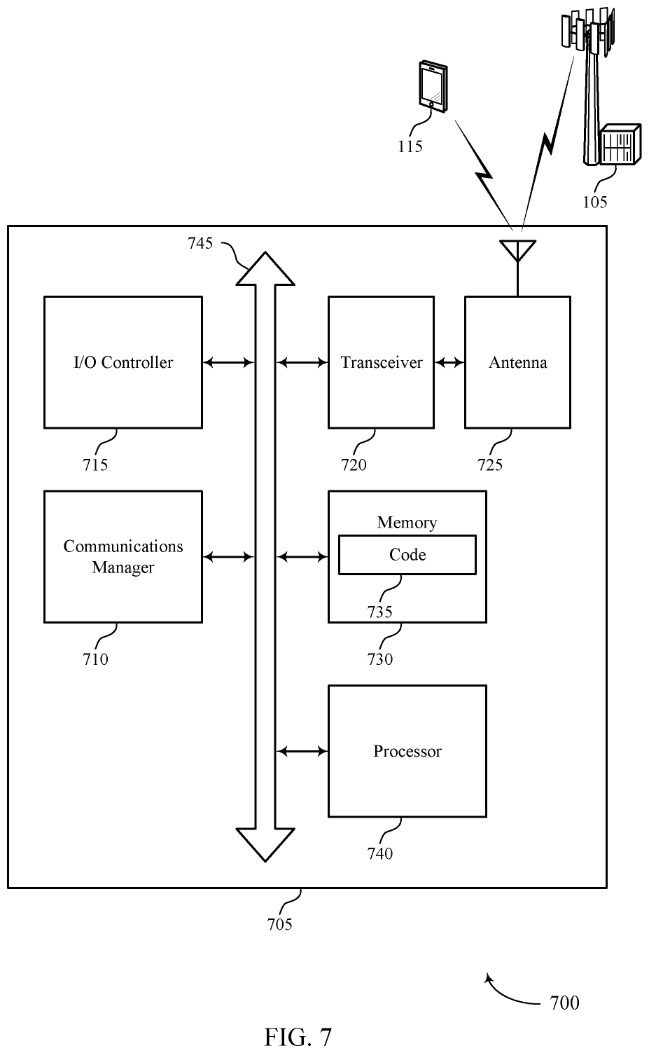

The receiver 410 may receive information such as packets, user data, or control information associated with various information channels (e.g., control channels, data channels, and information related to dynamic link recovery, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may transmit, to a second device, a first packet using a first sequence number, a first payload, and a first set of one or more transmission parameters, generate, based on the monitoring, a second packet including an error, the second packet using the first sequence number, a second payload, and a second set of one or more parameters different than the first set of one or more parameters, transmit the generated second packet to the second device, monitor, based on transmitting the first packet, for a first feedback message from the second device, monitor, based on transmitting the second packet, for a second feedback message from the second device, and receive the second feedback message from the second device based on monitoring for the second feedback message. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

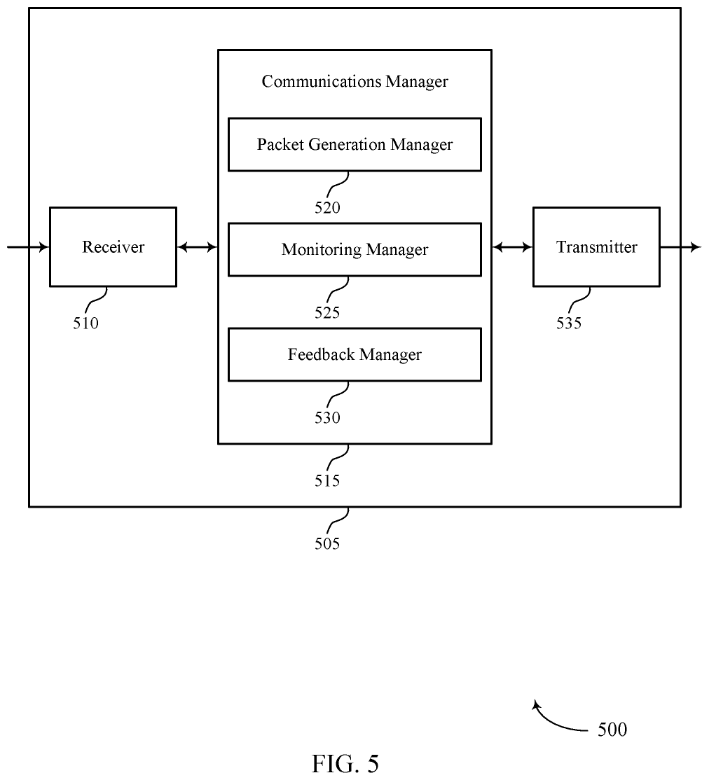

FIG. 5 shows a block diagram 500 of a device 505 that supports dynamic link recovery in accordance with aspects of the present disclosure. The device 505 may be an example of aspects of a device 405, as described herein. The device 505 may include a receiver 510, a communications manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to dynamic link recovery, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a packet generation manager 520, a monitoring manager 525, and a feedback manager 530. The communications manager 515 may be an example of aspects of the communications manager 710 described herein.

The packet generation manager 520 may transmit, to a second device, a first packet using a first sequence number, a first payload, and a first set of one or more transmission parameters, generate, based on the monitoring, a second packet including an error, the second packet using the first sequence number, a second payload, and a second set of one or more parameters different than the first set of one or more parameters, and transmit the generated second packet to the second device.

The monitoring manager 525 may monitor, based on transmitting the first packet, for a first feedback message from the second device and monitor, based on transmitting the second packet, for a second feedback message from the second device.

The feedback manager 530 may receive the second feedback message from the second device based on monitoring for the second feedback message.

The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

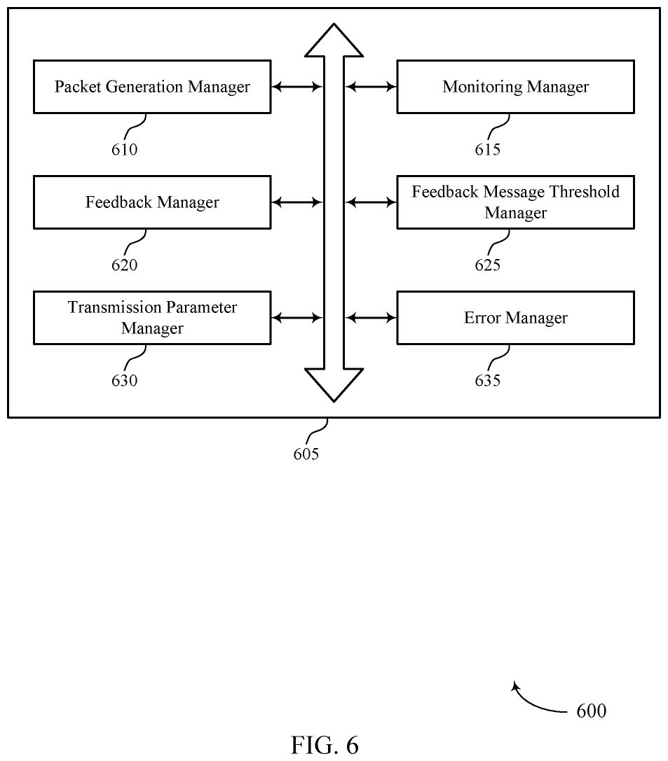

FIG. 6 shows a block diagram 600 of a communications manager 605 that supports dynamic link recovery in accordance with aspects of the present disclosure. The communications manager 605 may be an example of aspects of a communications manager 415, a communications manager 515, or a communications manager 710 described herein. The communications manager 605 may include a packet generation manager 610, a monitoring manager 615, a feedback manager 620, a feedback message threshold manager 625, a transmission parameter manager 630, and an error manager 635. Each of these modules may communicate, directly or indirectly, with one another (e.g., via one or more buses).

The packet generation manager 610 may transmit, to a second device, a first packet using a first sequence number, a first payload, and a first set of one or more transmission parameters. In some examples, the packet generation manager 610 may generate, based on the monitoring, a second packet including an error, the second packet using the first sequence number, a second payload, and a second set of one or more parameters different than the first set of one or more parameters. In some examples, the packet generation manager 610 may transmit the generated second packet to the second device. In some examples, transmitting, to the second device, a third packet having a second sequence number, a third payload, and the second set of one or more parameters, where the second feedback message includes a positive acknowledgement message.

In some examples, the packet generation manager 610 may transmit, to the second device, one or more packets using the first sequence number, the first payload, and the second set of one or more transmission parameters. In some cases, the first payload and the second payload are the same. In some cases, the first payload and the second payload are different.

The monitoring manager 615 may monitor, based on transmitting the first packet, for a first feedback message from the second device. In some examples, the monitoring manager 615 may monitor, based on transmitting the second packet, for a second feedback message from the second device.

The feedback manager 620 may receive the second feedback message from the second device based on monitoring for the second feedback message. The feedback message threshold manager 625 may identify a feedback message threshold time. In some examples, the feedback message threshold manager 625 may determine, based on monitoring for the first feedback message, that the feedback message threshold time has expired and the first device has not received the first feedback message, where generating the second packet is based on the determining.

The transmission parameter manager 630 may adjust one or more parameters of one or more packets. In some examples, the first set of one or more transmission parameters includes a first packet size, a first modulation order, a first coding rate, or a combination thereof, and where the second set of one more transmission parameters includes a second packet size, a second modulation order, a second coding rate, or a combination thereof.

The error manager 635 may introduce one or more errors to a packet. In some cases, the error includes a CRC error, or a message integrity check (MIC) error.

FIG. 7 shows a diagram of a system 700 including a device 705 that supports dynamic link recovery in accordance with aspects of the present disclosure. The device 705 may be an example of or include the components of device 405, device 505, as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may transmit, to a second device, a first packet using a first sequence number, a first payload, and a first set of one or more transmission parameters, generate, based on the monitoring, a second packet including an error, the second packet using the first sequence number, a second payload, and a second set of one or more parameters different than the first set of one or more parameters, transmit the generated second packet to the second device, monitor, based on transmitting the first packet, for a first feedback message from the second device, monitor, based on transmitting the second packet, for a second feedback message from the second device, and receive the second feedback message from the second device based on monitoring for the second feedback message.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting dynamic link recovery).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

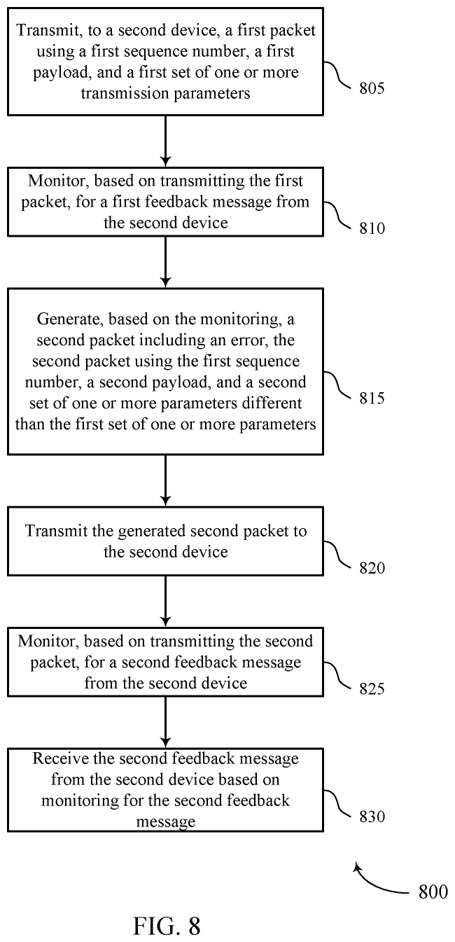

FIG. 8 shows a flowchart illustrating a method 800 that supports dynamic link recovery in accordance with aspects of the present disclosure. The operations of method 800 may be implemented by a device or its components as described herein. For example, the operations of method 800 may be performed by a communications manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may transmit, to a second device, a first packet using a first sequence number, a first payload, and a first set of one or more transmission parameters. The operations of 805 may be performed according to the methods described herein. In some examples, aspects of the operations of 805 may be performed by a packet generation manager as described with reference to FIGS. 4 through 7.

At 810, the device may monitor, based on transmitting the first packet, for a first feedback message from the second device. The operations of 810 may be performed according to the methods described herein. In some examples, aspects of the operations of 810 may be performed by a monitoring manager as described with reference to FIGS. 4 through 7.

At 815, the device may generate, based on the monitoring, a second packet including an error, the second packet using the first sequence number, a second payload, and a second set of one or more parameters different than the first set of one or more parameters. The operations of 815 may be performed according to the methods described herein. In some examples, aspects of the operations of 815 may be performed by a packet generation manager as described with reference to FIGS. 4 through 7.

At 820, the device may transmit the generated second packet to the second device. The operations of 820 may be performed according to the methods described herein. In some examples, aspects of the operations of 820 may be performed by a packet generation manager as described with reference to FIGS. 4 through 7.

At 825, the device may monitor, based on transmitting the second packet, for a second feedback message from the second device. The operations of 825 may be performed according to the methods described herein. In some examples, aspects of the operations of 825 may be performed by a monitoring manager as described with reference to FIGS. 4 through 7.

At 830, the device may receive the second feedback message from the second device based on monitoring for the second feedback message. The operations of 830 may be performed according to the methods described herein. In some examples, aspects of the operations of 830 may be performed by a feedback manager as described with reference to FIGS. 4 through 7.

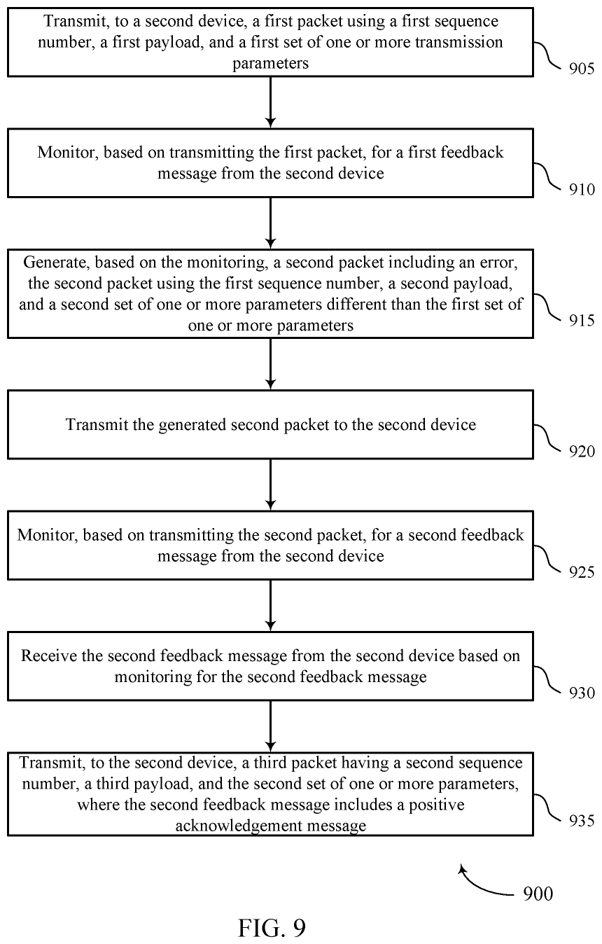

FIG. 9 shows a flowchart illustrating a method 900 that supports dynamic link recovery in accordance with aspects of the present disclosure. The operations of method 900 may be implemented by a device or its components as described herein. For example, the operations of method 900 may be performed by a communications manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may transmit, to a second device, a first packet using a first sequence number, a first payload, and a first set of one or more transmission parameters. The operations of 905 may be performed according to the methods described herein. In some examples, aspects of the operations of 905 may be performed by a packet generation manager as described with reference to FIGS. 4 through 7.

At 910, the device may monitor, based on transmitting the first packet, for a first feedback message from the second device. The operations of 910 may be performed according to the methods described herein. In some examples, aspects of the operations of 910 may be performed by a monitoring manager as described with reference to FIGS. 4 through 7.

At 915, the device may generate, based on the monitoring, a second packet including an error, the second packet using the first sequence number, a second payload, and a second set of one or more parameters different than the first set of one or more parameters. The operations of 915 may be performed according to the methods described herein. In some examples, aspects of the operations of 915 may be performed by a packet generation manager as described with reference to FIGS. 4 through 7.

At 920, the device may transmit the generated second packet to the second device. The operations of 920 may be performed according to the methods described herein. In some examples, aspects of the operations of 920 may be performed by a packet generation manager as described with reference to FIGS. 4 through 7.

At 925, the device may monitor, based on transmitting the second packet, for a second feedback message from the second device. The operations of 925 may be performed according to the methods described herein. In some examples, aspects of the operations of 925 may be performed by a monitoring manager as described with reference to FIGS. 4 through 7.

At 930, the device may receive the second feedback message from the second device based on monitoring for the second feedback message. The operations of 930 may be performed according to the methods described herein. In some examples, aspects of the operations of 930 may be performed by a feedback manager as described with reference to FIGS. 4 through 7.

At 935, the device may transmit, to the second device, a third packet having a second sequence number, a third payload, and the second set of one or more parameters, where the second feedback message includes a positive acknowledgement message. The operations of 935 may be performed according to the methods described herein. In some examples, aspects of the operations of 935 may be performed by a packet generation manager as described with reference to FIGS. 4 through 7.

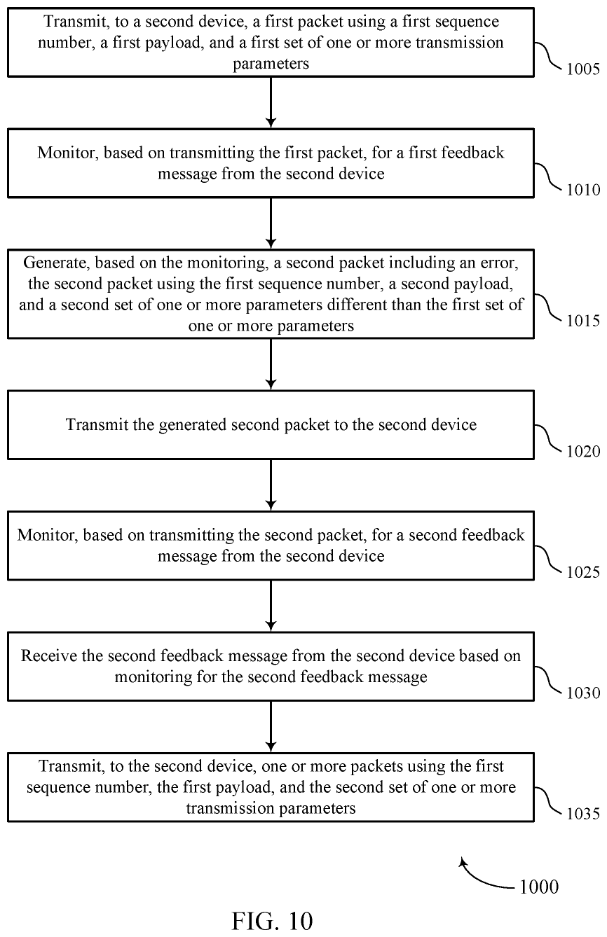

FIG. 10 shows a flowchart illustrating a method 1000 that supports dynamic link recovery in accordance with aspects of the present disclosure. The operations of method 1000 may be implemented by a device or its components as described herein. For example, the operations of method 1000 may be performed by a communications manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 1005, the device may transmit, to a second device, a first packet using a first sequence number, a first payload, and a first set of one or more transmission parameters. The operations of 1005 may be performed according to the methods described herein. In some examples, aspects of the operations of 1005 may be performed by a packet generation manager as described with reference to FIGS. 4 through 7.

At 1010, the device may monitor, based on transmitting the first packet, for a first feedback message from the second device. The operations of 1010 may be performed according to the methods described herein. In some examples, aspects of the operations of 1010 may be performed by a monitoring manager as described with reference to FIGS. 4 through 7.

At 1015, the device may generate, based on the monitoring, a second packet including an error, the second packet using the first sequence number, a second payload, and a second set of one or more parameters different than the first set of one or more parameters. The operations of 1015 may be performed according to the methods described herein. In some examples, aspects of the operations of 1015 may be performed by a packet generation manager as described with reference to FIGS. 4 through 7.

At 1020, the device may transmit the generated second packet to the second device. The operations of 1020 may be performed according to the methods described herein. In some examples, aspects of the operations of 1020 may be performed by a packet generation manager as described with reference to FIGS. 4 through 7.

At 1025, the device may monitor, based on transmitting the second packet, for a second feedback message from the second device. The operations of 1025 may be performed according to the methods described herein. In some examples, aspects of the operations of 1025 may be performed by a monitoring manager as described with reference to FIGS. 4 through 7.

At 1030, the device may receive the second feedback message from the second device based on monitoring for the second feedback message. The operations of 1030 may be performed according to the methods described herein. In some examples, aspects of the operations of 1030 may be performed by a feedback manager as described with reference to FIGS. 4 through 7.

At 1035, the device may transmit, to the second device, one or more packets using the first sequence number, the first payload, and the second set of one or more transmission parameters. The operations of 1035 may be performed according to the methods described herein. In some examples, aspects of the operations of 1035 may be performed by a packet generation manager as described with reference to FIGS. 4 through 7.

What is claimed is:

1. A method for wireless communications at a first device, comprising:
transmitting, to a second device, a first packet using a first sequence number, a first payload, and a first set of one or more transmission parameters;
monitoring, based at least in part on transmitting the first packet, for a first feedback message from the second device;
generating, based at least in part on the monitoring, a second packet comprising an error, the second packet using the first sequence number, a second payload, and a second set of one or more parameters different than the first set of one or more parameters;
transmitting the generated second packet to the second device;
monitoring, based at least in part on transmitting the second packet, for a second feedback message from the second device; and
receiving the second feedback message from the second device based at least in part on monitoring for the second feedback message.

2. The method of claim 1, further comprising:
transmitting, to the second device, a third packet having a second sequence number, a third payload, and the second set of one or more parameters, wherein the second feedback message comprises a positive acknowledgement message.

3. The method of claim 1, further comprising:
transmitting, to the second device, one or more packets using the first sequence number, the first payload, and the second set of one or more transmission parameters.

4. The method of claim 1, further comprising:
identifying a feedback message threshold time; and
determining, based at least in part on monitoring for the first feedback message, that the feedback message threshold time has expired and the first device has not received the first feedback message, wherein generating the second packet is based at least in part on the determining.

5. The method of claim 1, wherein the first set of one or more transmission parameters comprises a first packet size, a first modulation order, a first coding rate, or a combination thereof, and wherein the second set of one more transmission parameters comprises a second packet size, a second modulation order, a second coding rate, or a combination thereof.

6. The method of claim 1, wherein the error comprises a cyclic redundancy check (CRC) error, or a message integrity check (MIC) error.

7. The method of claim 1, wherein the first payload and the second payload are the same.

8. The method of claim 1, wherein the first payload and the second payload are different.

9. An apparatus for wireless communications at a first device, comprising:
a processor,
memory coupled with the processor; and
instructions stored in the memory and executable by the processor to cause the apparatus to:
transmit, to a second device, a first packet using a first sequence number, a first payload, and a first set of one or more transmission parameters;
monitor, based at least in part on transmitting the first packet, for a first feedback message from the second device;
generate, based at least in part on the monitoring, a second packet comprising an error, the second packet using the first sequence number, a second payload, and a second set of one or more parameters different than the first set of one or more parameters;
transmit the generated second packet to the second device;
monitor, based at least in part on transmitting the second packet, for a second feedback message from the second device; and
receive the second feedback message from the second device based at least in part on monitoring for the second feedback message.

10. The apparatus of claim 9, wherein the instructions are further executable by the processor to cause the apparatus to:
transmit, to the second device, a third packet having a second sequence number, a third payload, and the second set of one or more parameters, wherein the second feedback message comprises a positive acknowledgement message.

11. The apparatus of claim 9, wherein the instructions are further executable by the processor to cause the apparatus to:
transmit, to the second device, one or more packets using the first sequence number, the first payload, and the second set of one or more transmission parameters.

12. The apparatus of claim 9, wherein the instructions are further executable by the processor to cause the apparatus to:
identify a feedback message threshold time; and
determine, based at least in part on monitoring for the first feedback message, that the feedback message threshold time has expired and the first device has not received the first feedback message, wherein generating the second packet is based at least in part on the determining.

13. The apparatus of claim 9, wherein the first set of one or more transmission parameters comprises a first packet size, a first modulation order, a first coding rate, or a combination thereof, and wherein the second set of one more transmission parameters comprises a second packet size, a second modulation order, a second coding rate, or a combination thereof.

14. The apparatus of claim 9, wherein the error comprises a cyclic redundancy check (CRC) error, or a message integrity check (MIC) error.

15. The apparatus of claim 9, wherein the first payload and the second payload are the same.

16. The apparatus of claim 9, wherein the first payload and the second payload are different.

17. An apparatus for wireless communications at a first device, comprising:
means for transmitting, to a second device, a first packet using a first sequence number, a first payload, and a first set of one or more transmission parameters;
means for monitoring, based at least in part on transmitting the first packet, for a first feedback message from the second device;
means for generating, based at least in part on the monitoring, a second packet comprising an error, the second packet using the first sequence number, a second payload, and a second set of one or more parameters different than the first set of one or more parameters;
means for transmitting the generated second packet to the second device;
means for monitoring, based at least in part on transmitting the second packet, for a second feedback message from the second device; and
means for receiving the second feedback message from the second device based at least in part on monitoring for the second feedback message.

18. The apparatus of claim 17, further comprising:
means for transmitting, to the second device, a third packet having a second sequence number, a third payload, and the second set of one or more parameters, wherein the second feedback message comprises a positive acknowledgement message.

19. The apparatus of claim 17, further comprising:
means for transmitting, to the second device, one or more packets using the first sequence number, the first payload, and the second set of one or more transmission parameters.

20. The apparatus of claim 17, further comprising:
means for identifying a feedback message threshold time; and
means for determining, based at least in part on monitoring for the first feedback message, that the feedback message threshold time has expired and the first device has not received the first feedback message, wherein generating the second packet is based at least in part on the determining.
